(19) United States
(12) Patent Application Publication
(10) Pub. No.: US 2014/0214602 A1
(43) Pub. Date: Jul. 31, 2014

(54) QUEUE-REDUCING RETAIL SYSTEM

(71) Applicant: Tappr, Inc., Milwaukee, WI (US)

(72) Inventors: RYAN SCOTT KONICEK, Milwaukee, WI (US); Nicholas Errol Gartmann, Shorewood, WI (US); Richard James Allen, III, Milwaukee, WI (US)

(73) Assignee: Tappr, Inc., Milwaukee, WI (US)

(21) Appl. No.: 13/954,590

(22) Filed: Jul. 30, 2013

Related U.S. Application Data
(60) Provisional application No. 61/677,361, filed on Jul. 30, 2012.

(51) Int. Cl. G06Q 30/06; G06Q 20/32

(52) U.S. Cl. CPC G06Q 30/0633; G06Q 20/322
USPC 705/26.8

(57) ABSTRACT

The present invention provides a prepayment system that uses a smart phone or similar device to present a unique graphic identifier to the retail individual that can quickly allow that retail individual to match purchasers with purchased items. The ability to work visually at a greater distance and in noisy environments can significantly reduce the point of exchange queue and improve the customer experience.

### CROSS REFERENCE TO RELATED APPLICATION

This application claims the benefit of US provisional application 61/677,361 filed Jul. 30, 2012 and hereby incorporated by reference.

### STATEMENT REGARDING FEDERALLY SPONSORED RESEARCH OR DEVELOPMENT

—

### BACKGROUND OF THE INVENTION

The present invention relates to a system and method for managing retail sales, and in particular, to a prepayment system that allows rapid completion of a point of exchange transactions useful, for example, for potentially high-queue retail environments such as bars, concession stands and the like.

The processing of retail transactions typically includes the stages of selecting an item for purchase, completing payment for the purchase, and taking possession of the purchased item typically at a point of exchange. These time and personnel costs required to complete these first two stages can be greatly reduced by on-line ordering, for example, allowing the consumer to select the item and process payment remotely, for example, using a remote computer. The consumer may view an online catalog or menu and make payment, for example, using a credit card processed over the Internet.

The disadvantage of typical online purchasing is the delay in taking possession of the purchased item, a stage that is typically completed by shipping the product to the consumer. It is known, however, to combine the online ordering model with an option to pick up the purchased product at a retail outlet. In such cases, normally the customer will have entered unique identifying information at the time of payment processing, for example her name, which is then provided to sales personnel at the retail outlet who use this information to properly deliver the product to the customer.

### SUMMARY OF THE INVENTION

The present inventors have recognized that the “hybrid” online ordering/retail pickup model, while speeding transactions in many cases, can fundamentally interfere with the immediacy of the retail experience in which the customer location at the retail environment may be part of the purchasing decision (impulse or convenience purchasing) and may be advantageously used by the customer to simplify the purchasing process (selecting among what is easily available). Further, the benefits of time efficiencies provided by online selection and ordering by the customer can often be lost when there is a bottleneck at the point of exchange, something that is relatively common in retail environments dealing with large volumes of goods and subject to significant peak demand, for example, at a busy bar or a concession stand at an event such as a baseball game, opera or the like. Queuing at the point of exchange can be a particular problem in such situations when the environment is noisy, and close proximity to the retail individual is necessary for the customer to identify herself and her purchase.

The present invention addresses this latter problem by a prepayment system that uses a smart phone or similar device to present a unique graphic identifier to the retail individual that can quickly allow that retail individual to match purchasers with purchased items, The ability to work visually at a greater distance and in noisy environments can significantly reduce the point of exchange queue and improve the customer experience. The former problem, that the selection efficiencies of the retail model are lost with online ordering, is addressed through a geolocation system that provides the customer with a subset of purchases based on their location.

These particular objects and advantages may apply to only some embodiments falling within the claims and thus do not define the scope of the invention.

### BRIEF DESCRIPTION OF THE DRAWINGS

FIG. 1 is a diagrammatic representation of principal components in one implementation of the present invention allowing an individual with a mobile phone to order a drink from a bar by communicating with a centralized server system;

FIG. 2 is a logical representation of a database implemented by the centralized server system for matching users to local bar locations and menus based on the user's current location

FIG. 3 is a simplified map showing a location of a user in proximity to several retail environments;

FIG. 4 is a screenshot that may be displayed on a smart phone showing a listing of retail environments near the user;

FIG. 5 is a screenshot similar to that of FIG. 4 showing a menu for one retail environment selected by the user from the list of FIG. 4:

FIG. 6 is a status display visible to the user of the smart phone after placement of and payment for the order indicating the order status and allowing entry of the tip;

FIG. 7 is a view of a terminal at the retail environment located at a separate point of exchange for online orders and showing a pull down menu for updating order status and the display of a unique graphic element for identifying each completed order;

FIG. 8 is a screenshot similar to FIGS. 5 and 6 showing the identifying graphic element matching that of the retail environment shown in FIG. 7 as displayed on the user's smart phone;

FIG. 9 is a screenshot of a message sent to a third party indicating that a drink has been purchased for them by the user using the system of the present invention; and

FIG. 10 is a simplified logical representation of a bar tab over 24 hours showing aggregation of charges possible with the present invention for reduced processing fees.

### DETAILED DESCRIPTION OF THE PREFERRED EMBODIMENT

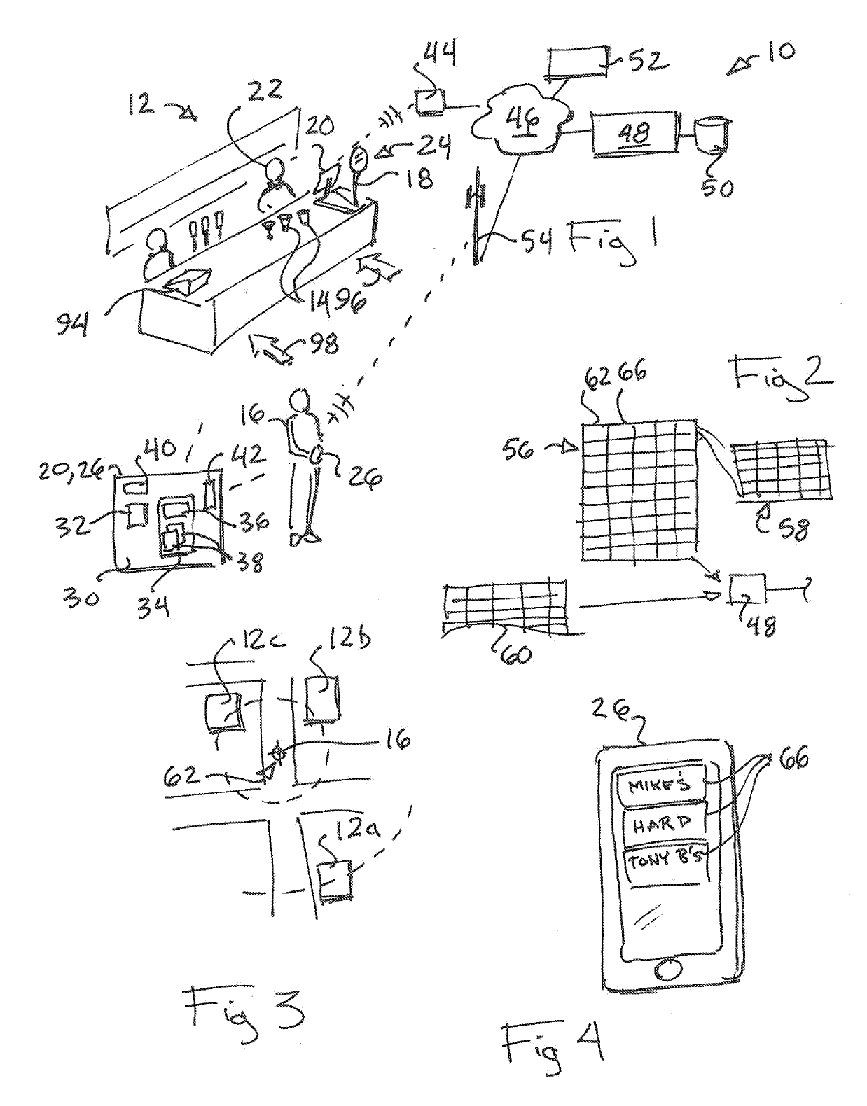

Referring now to FIG. 1, a retailing system 10 of the present invention may work in a retail environment 12, for example, a bar, for the sale of merchandise 14. in this case alcoholic or other beverages desired by a customer 16.

The invention provides for a station 18 at the retail environment 12, the station 18 providing a tablet computer 20 or the like configured for access by a retailing individual 22, for example, a bartender. The station 18 may include a placard 24 indicating that it is a location for a point of exchange for the retailing system 10, distinct from a point of exchange for conventional retailing, where the customer 16 may receive the merchandise 14 using the present invention.

As will be discussed in further detail below, this invention works in conjunction with a smart phone 26 or similar device in the possession of the customer 16 through which the customer 16 may place orders to be picked up at the station 18.

Each of the tablet computer 20 and smart phone 26 may provide for a computing platform 30 having a processor 32 communicating with a memory 34. The memory 34 may hold an operating system 36 and one or more application programs 38 including an application implementing a portion of the retailing system 10 of the present invention. In the case of the smart phone 26, the computing platform 30 may include a geolocation device such as a GPS receiver 40 or wireless triangulation system. Both of the tablet computer 20 and smart phone 26 may provide for wireless communication through a wireless port 42 providing one or more of cellular phone connectivity or local area wireless connectivity, for example, a Wi-Fi connection.

In a typical installation, the tablet computer 20 will communicate with a wireless router 44 communicating over the Internet 46 with a server computer 48. The server computer 48 also provides at least one processor and an associated memory holding one or more computer programs to implement features to be described below. The server computer 48 may further provide a connection with a database 50 managing transaction data as will also be discussed.

Generally the server computer 48 may also communicate with a credit card processing server 52 or the like over the Internet 46 for the processing of credit cards or other electronically implemented payment systems. Generally, the smart phone 26 may also communicate via the Internet 46 with the server computer 48 typically by way of a cell phone tower 54 or the like but also potentially through the wireless router 44.

Referring now to FIG. 2, the database 50 may provide for a retail environment table 56 having logical rows each associated with a different retail environment 12 (such as a bar) and having logical columns indicating within each row, for example, the name of the retail environment 12, its geographic location, a billing code, and a key ID. The key ID may be linked, for example, to a menu table 58 providing a menu for a given retail environment 12. The menu table may include logical rows representing merchandise that can be purchased (e.g. drink types) and logical columns within each row providing details with respect to the merchandise, in this example, drink name, drink price, and discounts or specials for the particular retail environment 12 using the present invention.

The server computer 48 may also hold a registered user table 60 providing information about each registered customer 16. The registered user table 60 may provide for logical rows for each customer 16 and logical columns providing information about the customer, for example billing information (including, for example, a credit card number, expiration date and the like), demographic information (including age and gender), home address, preferred social network links for posting information about purchases, customer preferences and purchase history for frequent purchaser awards and the like. This registration process may be part of obtaining the application program 38 by the customer 16.

Referring now to FIG. 3, in an example use of the retailing system 10 of the present, the customer 16 may open the application program 38 which may employ the location hardware of the smart phone 26 to identify a location 62 of the customer 16 with respect to one or more retail environments 12a-12c near the customer 16. For example, the customer 16 may be walking down a street and the retail environments 12a-12c may be buildings near the customer 16 or on a projected trajectory of the customer 16 to a time in the future that may optionally be correlated with preparation time for particular merchandise.

The application server computer 48 may receive this information from the application program 38 using the hardware of the smart phone and the infrastructure described above. The server computer 48 upon receiving this information may consult with the database 50 to identify retail environments 12a-12c in the vicinity of the location 62 using the appropriate field in the retail environment table 56. It should be noted that there need be no legal relationship between the retail environments 12 other than resulting from their association with the retailing system 10.

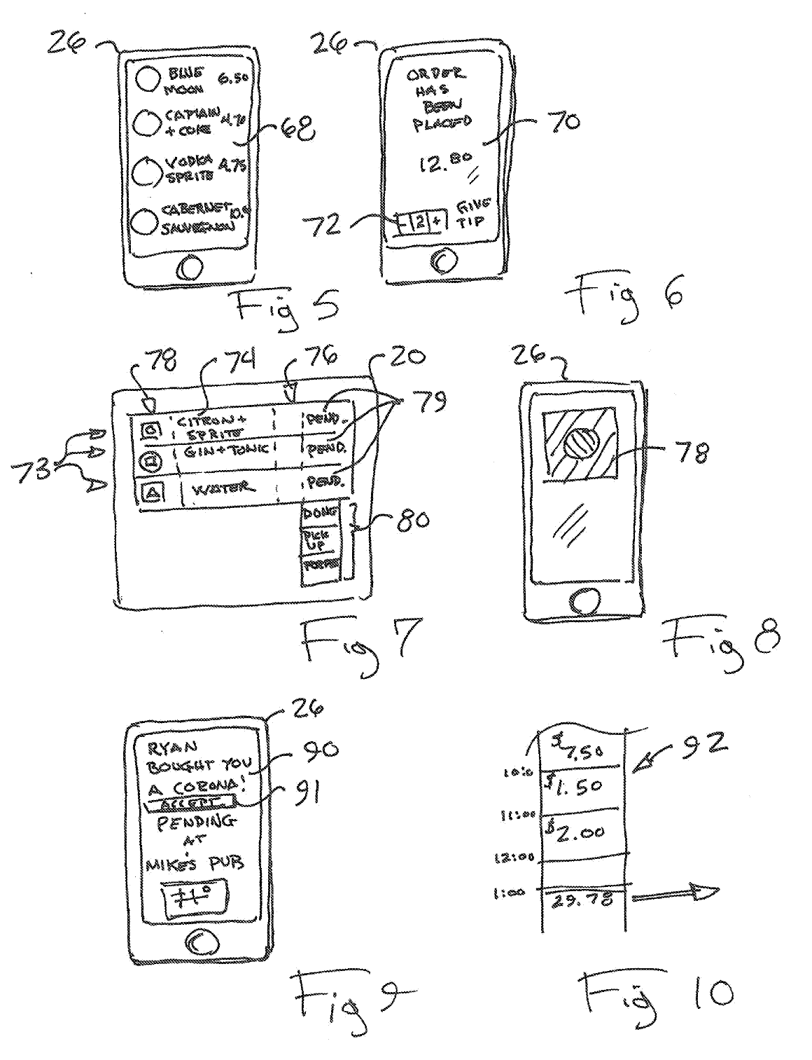

Referring now to FIGS. 4 and 5, the identity and other information about these retail environments 12a-12c then may be sent to the smart phone 26 which will provide a display listing different retail environments 12 by their names 66, for example, in order by distance. The customer 16 may then select one of the names 66, for example, by tapping a touchscreen over the name 66 to bring up a menu screen 68 (shown in FIG. 5) populated from the menu table 58 of the selective retail environment 12. This menu screen 68 may include sub screens (not shown) of a type known in the art allowing particular items to be ordered, designating an ordered quantity, and allowing authorization of a charge to a preregistered credit card or credit card entered through the smart phone or other payment system accessible through the smart phone 26. One subscreen may permit the customer 16 to add a free text note to the order either, for example, to indicate order details or preferences not otherwise provided by the menu screen 68.

Referring to FIG. 6, once an order has been placed, for example, by tapping an authorization button (not shown) on the smart phone 26, an order confirmation screen 70 may appear indicating that the order has been placed and providing an option for payment of a tip also using credit card or other payment information previously provided. The tip may be entered via a graphical widget 72, for example, calculating a default tip from the bill and allowing incrementing up and downward of that amount as desired by the user.

This order confirmation screen 70 will update itself indicating the status of the order as will be described below and may appear at this time and again after completion of the order when the merchandise 14 has been received by the customer 16. This latter occurrence allows continued adjustment of the tip for predetermined time window after completion of the order. The act of ordering may trigger an update to social network sites, when this option is enabled by the user, for example, indicating the user's location and their purchase.

Referring now to FIG. 7, the tablet computer 20 upon receipt of an order from a customer 16 using the retailing system 10 of the present invention, may provide a display comprised of multiple lines 73, one for each order from each customer 16. Each line 73 will provide identifying information about the order 74, for example, a drink type, and may include free-text notes as provided through the subscreens of the menu screen 68 discussed above. Each line 73 may further provide for a dollar amount 76 indicating an amount of payment that is required and its status as authorized.

Each line 73 may further include an order status button 79. The status button 79 when tapped presents a status menu 80 allowing the bartender or retailing individual 22 to indicate a status of the order as “pending”, “done” or completed, “picked up”, or “forfeited”. This latter forfeited status allows the payment by the customer 16 to be forfeited, for example, in the case that the customer 16 is below illegal purchasing age. This option provides for a deterrent for misuse of the retailing system 10 in certain instances including the sale of alcoholic beverages that may offset any temptation for its use to avoid age restrictions.

Importantly, once payment is confirmed per dollar amount 76, the line 73 displays a unique graphical reference 78 that will be used to facilitate the exchange of the merchandise 14 with the customer 16 in a rapid and efficient way. Ideally the graphical reference 78 will be composed of simple combinations of colors and shapes that can be recognized from a distance of several feet to several yards when displayed on a typical smart phone display. For example, the graphical references 78 may be made up of a combination of a stock set of background symbols (for example geometric shapes), background colors, foreground symbols (different and smaller geometric shapes) and foreground colors. It will be recognized that as few as five of each of these categories of symbol characteristics can provide 625 different combinations that may be randomly selected to exclude those combinations currently associated with pending orders. Additional categories and symbols may be provided as necessary.

Alternatively, other graphical representations, for example, including pictures that may be easily recognized may be chosen. In one embodiment, simple phrases that can also be spoken or displayed may be provided instead or as a backup matter.

Referring now to FIGS. 1, 7 and 8, when the retailing individual 22 changes the status of line 73 to “done” on the tablet computer 20, the cell phone 26 will display the graphical reference 78 associated with the particular line 73 and the order as pushed from the server computer 48. The customer 16 may then approach the station 18 and quickly obtain the purchased merchandise 14 simply by displaying the phone 26 to be viewable by the retailing individual 22. In noisy environments, no speaking is necessary for this transaction, and a skilled individual may be able to match orders to graphical references 78 and to dispense the merchandise 14 faster than a queue can form.

The station 18 maybe removed, for example, from a cash register 94 used by other patrons to provide for two distinct exchange areas 96 and 98 eliminating a sense of unfairness that some individuals using the retailing system 10 of the present invention are able to receive their orders more quickly than those queuing for conventional transactions. The two exchange areas 96 and 98 may further provide improved point of exchange experience for all customers by separating them from a single queuing area.

Referring now to FIG. 9, the present invention allows an individual to make the purchase described above but to designate (in a sub screen of the menu screen 68) another individual to receive the order. A list of friends for whom drinks may he purchased may be for example imported from a social networking site such as Facebook using the Facebook API. In this case, the server computer 48 pushes a message 90 to a cell phone 26° of the third-party indicating the fact of the purchase, its status, and the location of the retail environment 12. Alternatively this message may be pushed via a social network service. Accepting this purchase per accept button 91, will provide a screen display similar to that shown in FIG. 8. Such third-party purchases may, for example, be associated with discounts in the menu database 50 (displayed on the menu screen 68) in order to promote possibly new customers into trying a particular retail environment 12 frequented by their friends. Knowledge about the demographics of the customer 16 making the purchase may also be used to selectively provide particular records of the menu table 58 including discounts or sales.

Referring now to FIG. 10, the database 50 may keep a running chronological tab, for example, in a tab table 92 logically linked to an individual in the customer table 60, that may postpone invoking of a credit card processing server 52 until the end of a day so as to aggregate multiple small purchases into a larger purchase subject to lower credit card transaction completion fees.

Generally it will be appreciated that the database 50 may also hold an ongoing transaction log that can be used to obtain marketing information relative to particular retail environments 12 and customer 16 including, for example, providing the ability to identify the most popular retail environments 12, the amount of money received by each retail environment 12, what drinks or merchandise 14 are most popular, the gender ratios of those using the retailing system 10, trends in sales of products from given retail environments 12, clusters of sales in times and breakouts according to any of the demographic elements held in the table 60. This information may be used to target particular sales or specials to individuals and to provide for useful feedback to the retail environment 12 and manufacturers of merchandise 14. This information may also be used to reward customer loyalty or affinity points, for example, in the form of graphic icons (“badges) or the like provided to the user cell phone 26 indicating their purchase of particular products in particular time windows which may also be used to generate promotions coupons and discounts for the individual.

The status updates may include more information about the time necessary to prepare the product, for example, when used with food items that need to be cooked or prepared so that an individual may preorder efficiently before they arrive at the retail environment 12. Clearly the system may be used to provide for standard table reservations, questionnaires and the like in adjunct to its principal purpose of providing a retail conduit.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A retailing system comprising:
a mobile device having a graphic screen and executing an application program to receive ordering information from a user identifying a desired product in a retail environment for pickup; and
a transaction processing computer providing a graphic screen at a retail environment receiving the order providing order information on the graphic screen at the retail environment and assigning a unique graphical order representation that may be displayed on the graphic screen of the mobile device and the graphic screen at the retail environment to provide for rapid matching of orders and products.
